(19) United States
(12) Patent Application Publication
(10) Pub. No.: US 2003/0155464 A1
(43) Pub. Date: Aug. 21, 2003

(54) Device of wind electric power on transportation vehicles

(76) Inventor: Da-Chen Tseng, Lu Zhou City (TW)

Correspondence Address: RABIN & CHAMPAGNE, P.C., 1101 14 Street, N.W., Suite 500, Washington, DC, 20005, US

(21) Appl. No.: 10/077,995

(22) Filed: Feb. 20, 2002

(51) Int. Cl. B64D 41/00

(52) U.S. Cl. 244/58

(57) ABSTRACT

A device of wind electric power on transportation vehicles comprises at least one wind electric power-generating unit, the air inlet of which faces the windward side of the electric vehicle. The wind electric power-generating unit is connected to a rechargeable secondary battery in which stores input electricity generated by wind power to replenish power supply of the electric vehicle. The air inlet of the wind electric power-generating unit has a pair of air throttles that are controlled by a driving unit and can be pushed outwards to enlarge cross section area of said air inlet to help gather airflow when the vehicle is running.

### FIELD OF INVENTION

The present invention relates to a device of wind electric power on transportation vehicles, especially the device that utilizes wind power to generate electricity as auxiliary power supply of transportation vehicles.

### BACKGROUND OF INVENTION

To reduce the increasingly serious pollution owing to the wide use of gasoline, experts and scholars all over the world have long dedicated to the development of electric vehicles as transportation vehicles considering that they are qualified for environmental protection with high efficiency in using a variety of energy sources.

Take automobile as an example, there are three types of electric automobiles. The first one is called Electric Vehicle that stores electricity of electric utilities in the car borne battery. The second one is Solar Vehicle that carries multiple solar energy generating units to generate electricity to be stored in the car borne battery to propel motor. The third type of electric automobile generates electricity by using fuel battery. However, it is not widely used because of its huge volume and high cost. Besides all the three above-mentioned types, there are also some electric automobiles using all three ways of generating electricity.

However, the criteria by which each country judges the performance of electric vehicles are based on customers' demand and mainly concern with top speed, accelerating ability and the distance upon one charging (so called endurance). Any method that can optimize the performance is considered as important technical breakthrough in the design of electric vehicle and will contribute greatly to its popularization.

The traditional electric vehicle, as illustrated in FIG. 1, uses electric supply (10), or solar generator (11) or other electric power such as fuel battery (12) to store electricity into its car borne battery (13) in advance. When electric vehicle starts, the battery (13) transmits electricity to motor (14) to operate (15). Some vehicles are even equipped with a minor generator (16) that generates electricity through the revolving of axle to be stored in the battery (13). It can be seen from the above facts that traditional electric vehicle will consume a great amount of electricity upon start and is hard to recharge to assure its endurance. Therefore, traditional electric vehicle needs to be improved.

### SUMMARY OF THE INVENTION

The primary object of the present invention is to provide a device of wind electric power on transportation vehicles that can be used together with various traditional electrical installations. The present invention is a wind electric power-generating unit that unitizes wind power to generate electricity as auxiliary power supply to enhance the endurance of electric vehicle and further accelerate its speed.

The further object of the present invention is to provide a device of wind electric power on transportation vehicles, at its air inlet of the wind electric power generating unit there is installed a wind-gathering device that has a pair of air throttles to adjust cross section area of the air inlet.

Because the present invention can utilizes wind power to generate electricity when the electric vehicle is running, especially when it accelerates, to replenish power supply to enhance its endurance, the device of the present invention can be used in newly-built electric vehicles and even the existing ones as auxiliary power supply to improve its performance.

The device of wind electric power of the present invention can be installed on one of the transportation vehicles such as electric vehicles or motorcycles or bicycles, electric vessels, electric airplanes, etc. This device comprises at least one rechargeable secondary battery that can provide electricity to the electric transportation vehicle. Moreover, there is fixed a wind electric power-generating unit on the empennage and/or the top of the vehicle. The air inlet of the wind electric power-generating unit faces the windward side of the vehicle, which can help gather airflow when the vehicle is running. The wind electric power-generating unit is connected to the secondary battery that can store input electricity generated by wind power to replenish power supply. A preferred embodiment of the present invention, at its air inlet of the wind electric power generating unit there is also installed a wind-gathering device that has a pair of air throttles, preferred that are controlled by motor, to adjust cross section area of said air inlet.

### BRIEF DESCRIPTION OF DRAWINGS

The attached figures illustrate the preferred embodiment of the device of wind electric power of the present invention.

FIG. 1 is schematic of the power supply of traditional electric vehicle.

FIG. 2 is flow chart of the device of wind electric power on transportation vehicles and its power utilization.

FIG. 3 and FIG. 4 are schematics of the embodiments of the present invention to be applied to general minibus on the top of which is installed the wind electric power generating unit; and wherein FIG. 3 also illustrates the direction of airflow.

FIG. 5 is schematic of the embodiment of the present invention to be applied to electric jeep.

FIG. 6 is schematic of the embodiment of the present invention to be applied to electric wagon on the front top of which is installed the wind electric power generating unit.

FIG. 7 is schematic of another embodiment of the present invention to be applied to minibus on the front nose of which is installed the wind electric power generating unit.

FIG. 8 is schematic of the embodiment of the present invention to be applied to bus on the back top of which is installed the wind electric power generating unit.

FIG. 9 is schematic of the embodiment of the present invention to be applied to electric motorcycle.

FIG. 10 is schematic of the embodiment of the present invention to be applied to electric bicycle.

FIG. 11 and FIG. 12 are schematics of the embodiments of the present invention to be applied to electric vessel.

FIG. 13 is top view of the wind electric power-generating unit of the present invention.

FIG. 14 is horizontal view of FIG. 13.

FIG. 15 is lateral view of FIG. 13.

FIG. 16 is similar to FIG. 13 but illustrates another embodiment.

FIG. 17 is horizontal view of FIG. 16.

FIG. 18 is similar to FIG. 4 but illustrates another embodiment.

FIG. 19 is top view of the embodiment of the wind electric power-generating unit in FIG. 18.

FIG. 20 is lateral view of FIG. 19.

FIG. 21 is lateral view of the embodiment of the wind electric power-generating unit in FIG. 5.

FIG. 22 is upward view of FIG. 21.

FIG. 23 is schematic of the embodiment of the present invention to be applied to airplane.

FIG. 24 is similar to FIG. 23 but illustrates another embodiment which having two row of the wind electric power-generating unit onto each aerofoil.

FIG. 25 is upward view of FIG. 24.

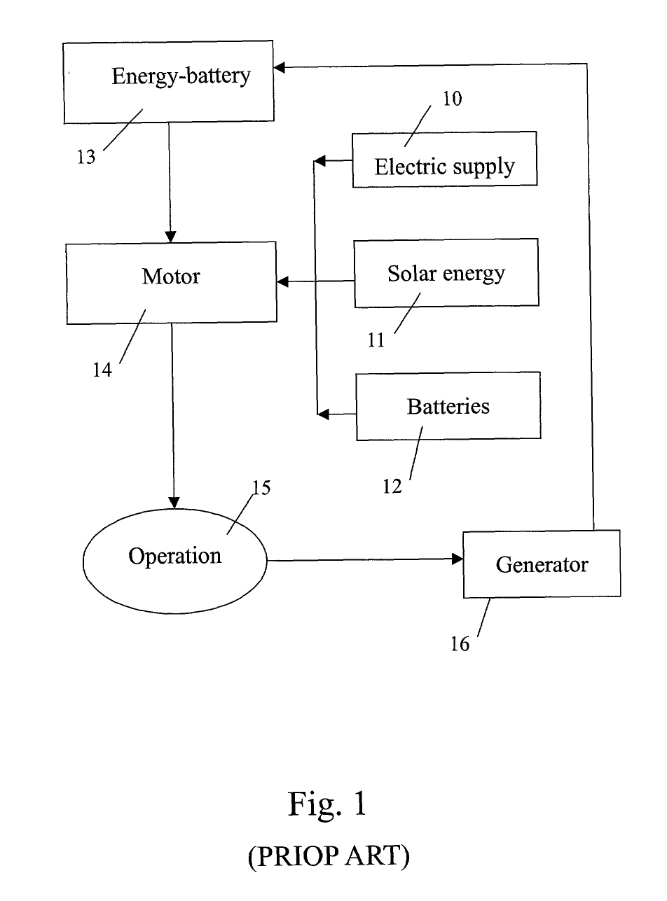

### DETAILED DESCRIPTION OF THE PREFERRED EMBODIMENT

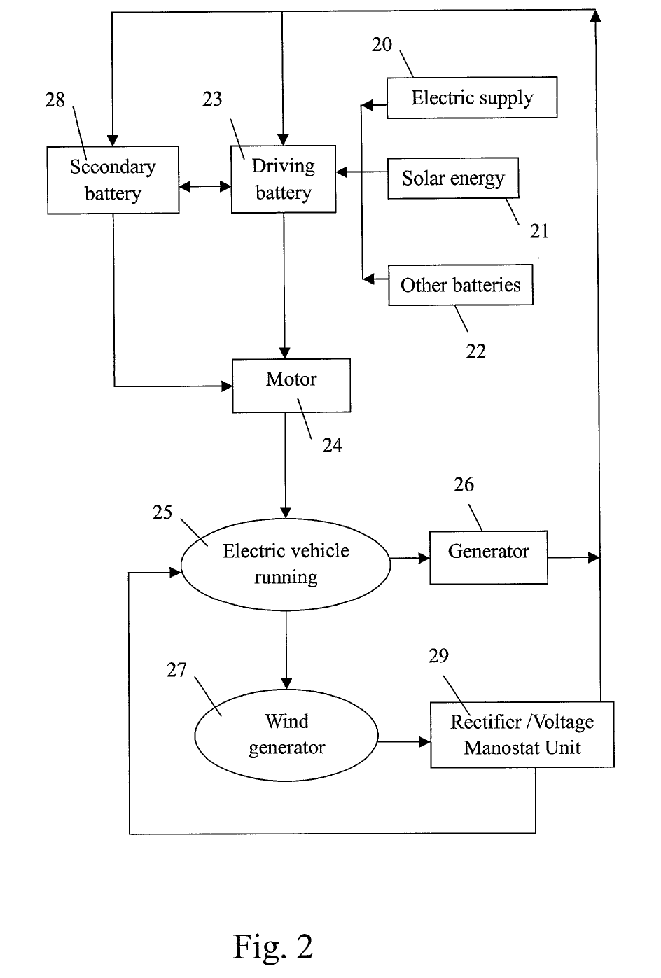

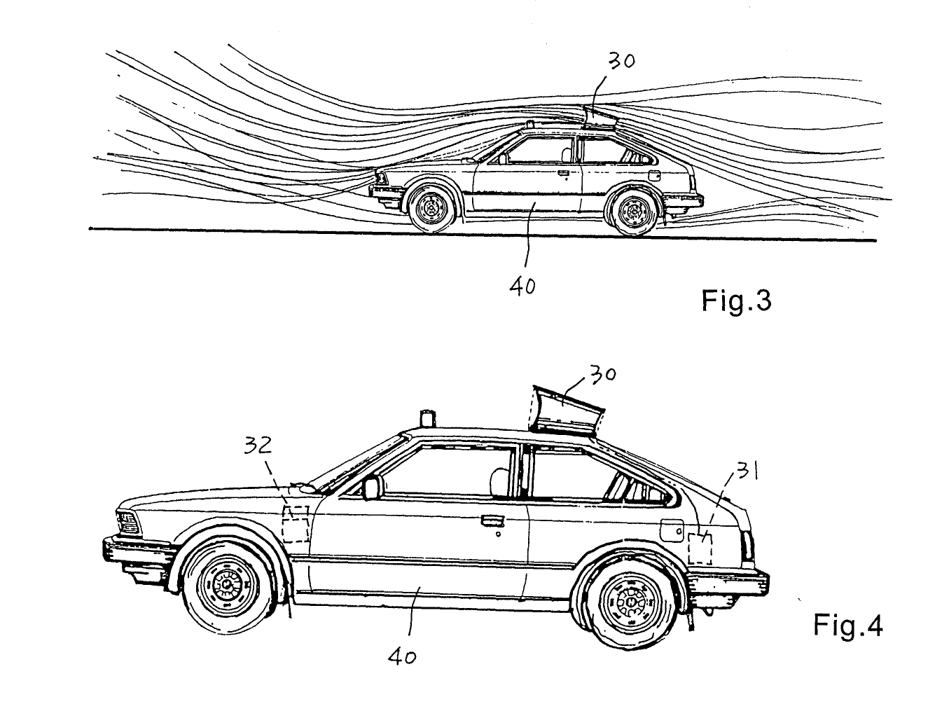

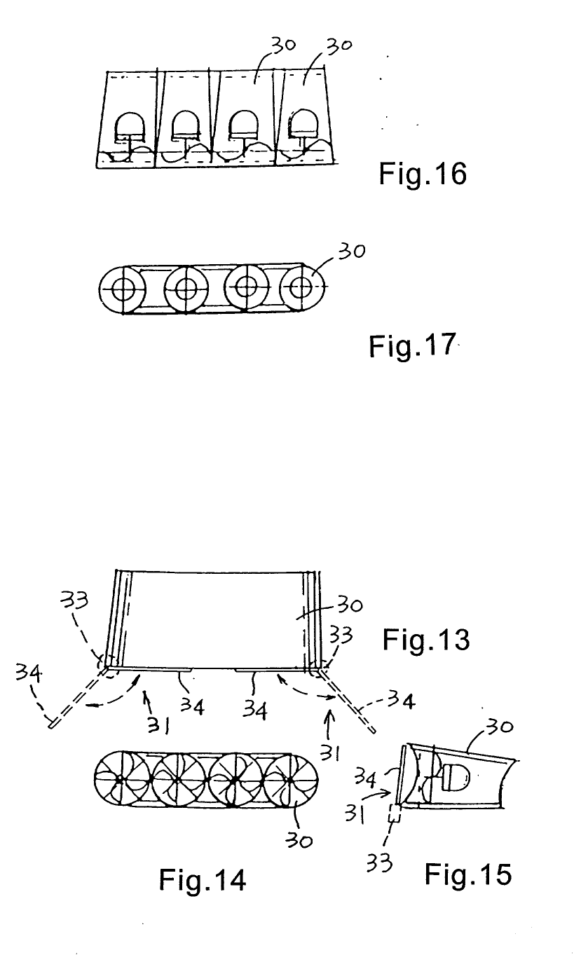

As illustrated in FIG. 3 and FIG. 4 and please refer to FIGS. 13-23, the device of wind electric power of the present invention comprises at least one wind electric power generating unit (30) that is fixed on vehicle (40) which as shown in FIGS. 13-23, preferred electric vehicle. The air inlet of said wind electric power generating unit (30) faces the windward side of the vehicle (40), which can help gather airflow when the vehicle (40) is running and promote wind electric power generating unit (30) to generate electricity to a motor or a battery. Electricity generated by wind electric power generating unit (30), as shown in FIG. 4, can be stored in a secondary battery (31) (to be connected to main battery 32 via built-in wire in the vehicle, figure omitted), and can replenish power supply (please refer to FIG. 2) to the motor of the vehicle to propel it to run as well as enhance the endurance of the vehicle since main battery (32) can supply more electricity to the motor. In short, a preferred embodiment of the present invention is as mentioned above to have at least two connected batteries installed on the electric vehicle (40), the first of which directly outputs electricity to motor, the second of which stores input electricity generated bye the wind electric power generating unit (30).

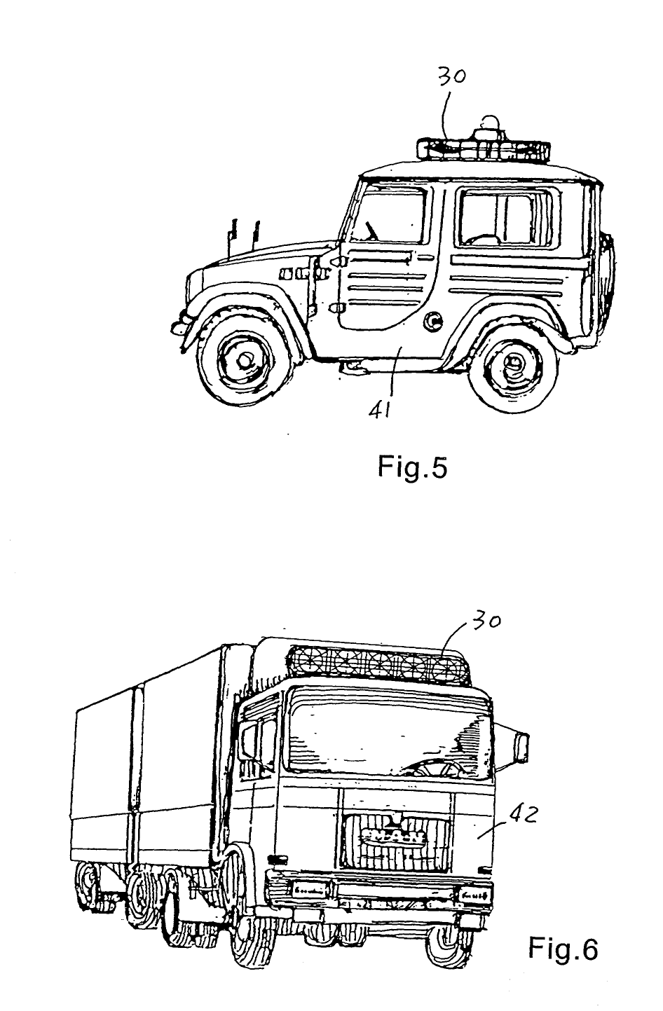

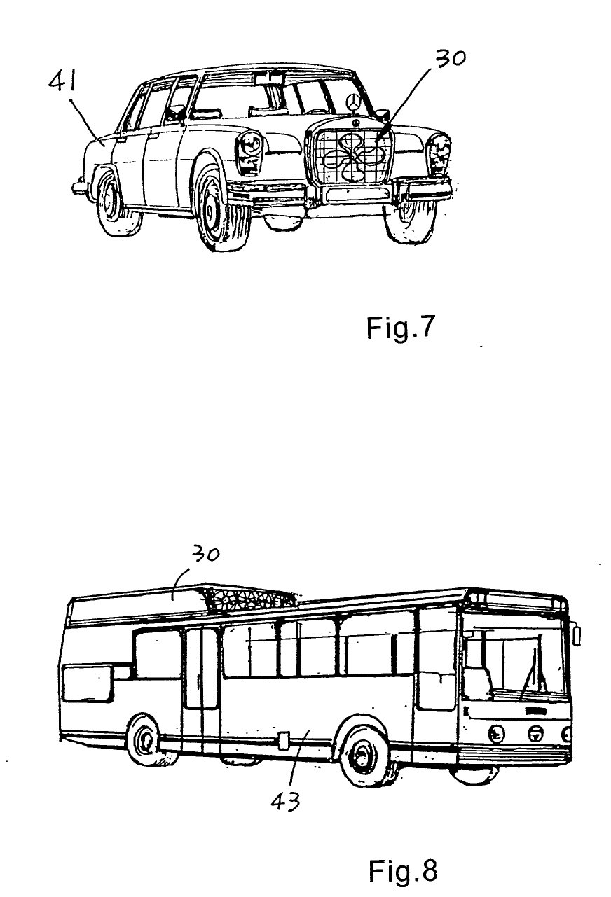

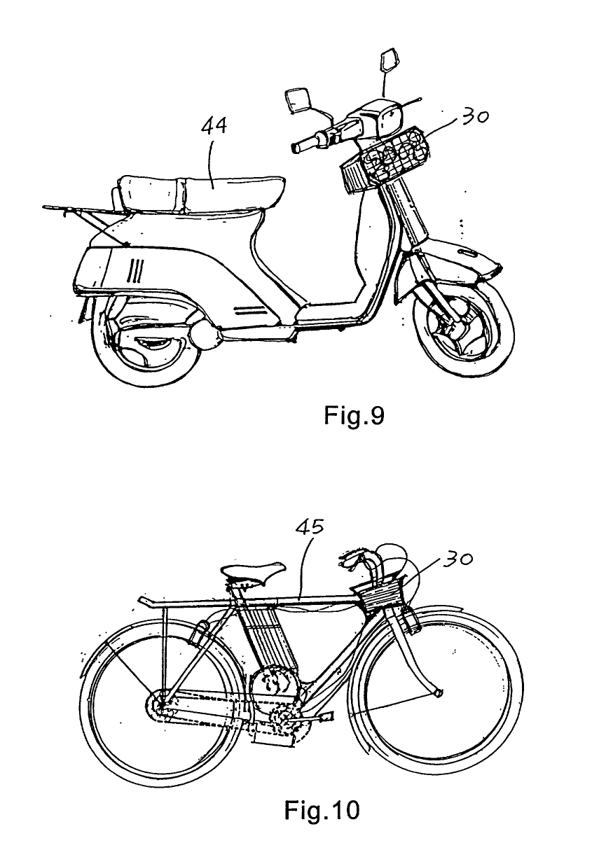

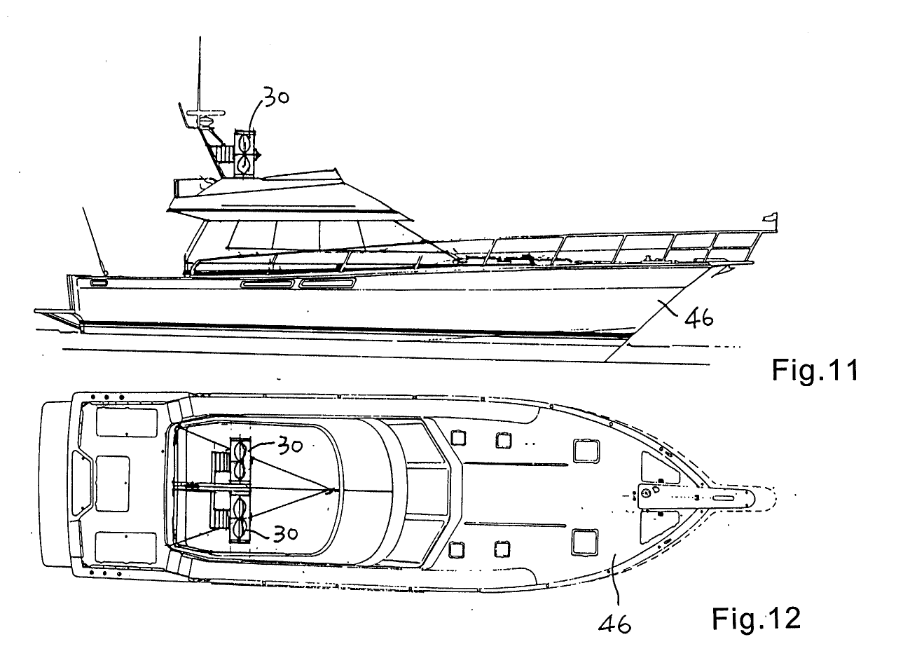

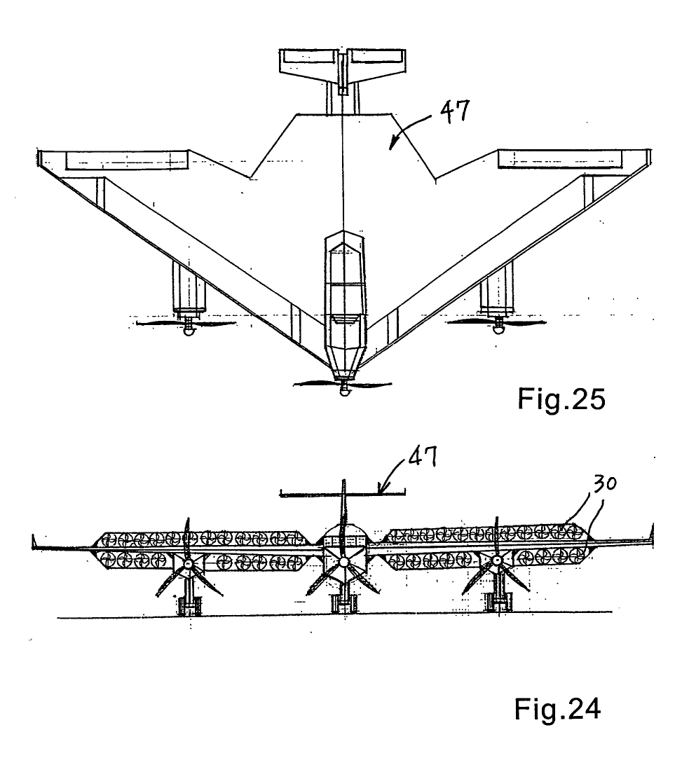

The electric transportation vehicles to which the present invention can be applied for minibus (40), preferred electric minibus, shown as FIG. 4 and FIG. 7; jeep (41), preferred electric jeep, of FIG. 5; wagon (42), preferred electric wagon of FIG. 6; bus (43), preferred electric bus, of FIG. 8; motorcycle (44), preferred electric motorcycle, of FIG. 9; bicycle (45), preferred electric bicycle, of FIG. 10; vessel (46), preferred electric vessel, of FIG. 11 and FIG. 12; or other oil tanker that needs wind power to replenish its power supply, etc. The wind electric power-generating unit (30) preferred is fixed on the top of the deck, or the stern, or at least one of the two gunwales of the vessel. When applied to electric bicycle or motorcycle, said wind electric power generating unit (30) is fixed on its front. FIG. 23 shown as a preferred embodiment of the present invention to be applied to airplane (47); and the wind electric generating unit (30) can be fixed on its wings or other proper place. When airplane is gliding, it gathers the strong airflow to propel the wind electric power-generating unit (30) to generate electricity. It is without doubt that airplane mentioned here is only one of the specific embodiments of various aircrafts. The present invention can also be applied to various other aircrafts, such as shown as FIG. 23 or FIG. 24, for both aero-detecting and recreation, even to glider. It can also be used together with other generating units such as solar energy generator as auxiliary power supply to enhance the aircrafts' endurance.

As mentioned above, the air inlet of said wind electric power generating unit (30) faces the windward side of the electric vehicle. Take electric vehicle (40) of FIG. 3 or electric vessel (46) of FIG. 11 and FIG. 12 as example, the wind electric power generating unit is better installed on the top of the transportation vehicle, which can help gather airflow and promote wind electric power generating unit (30) to generate electricity as auxiliary power supply to the motor.

As illustrated in FIG. 13 and FIG. 15, a preferred embodiment of the wind electric power generating unit (30) also includes a wind-gathering device (31) installed at the front of said wind electric power generating unit (30). Said wind-gathering device (31) comprises a pair of air throttles (34) that are controlled by a driving unit and can be pushed outwards to adjust cross section area of said air inlet. Said driving unit can employ a servomotor (33) to drive a pivot that enables the air throttles (34) attached to it open and close in a certain angle. When the electric vehicle remains motionless, the air throttles are closed. Once the vehicle is running, the air throttles (34) are pushed outwards by the driving unit to enlarge the cross section area of the air inlet to gather airflow.

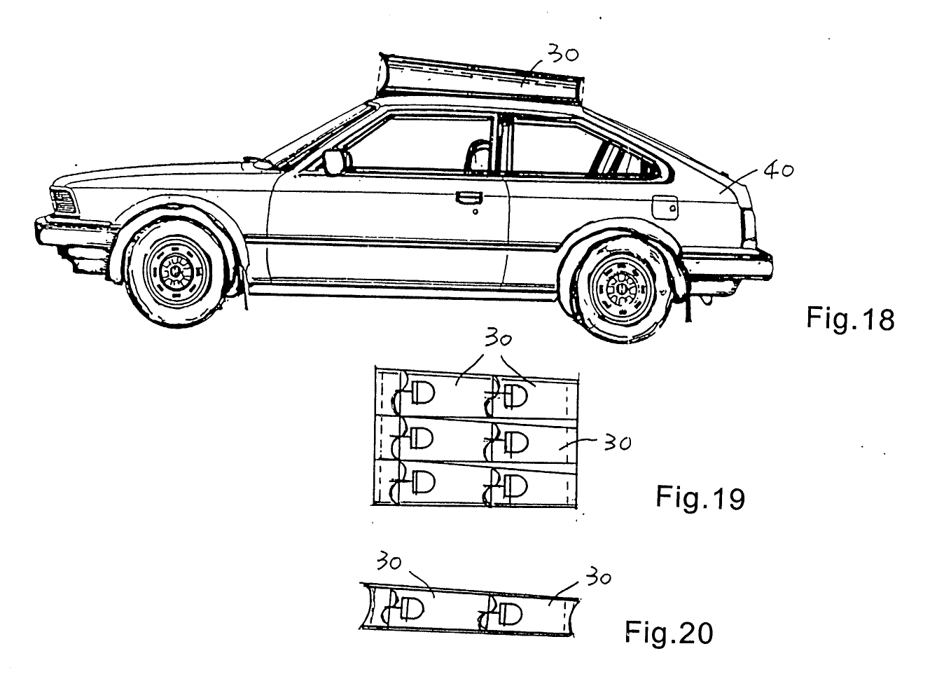

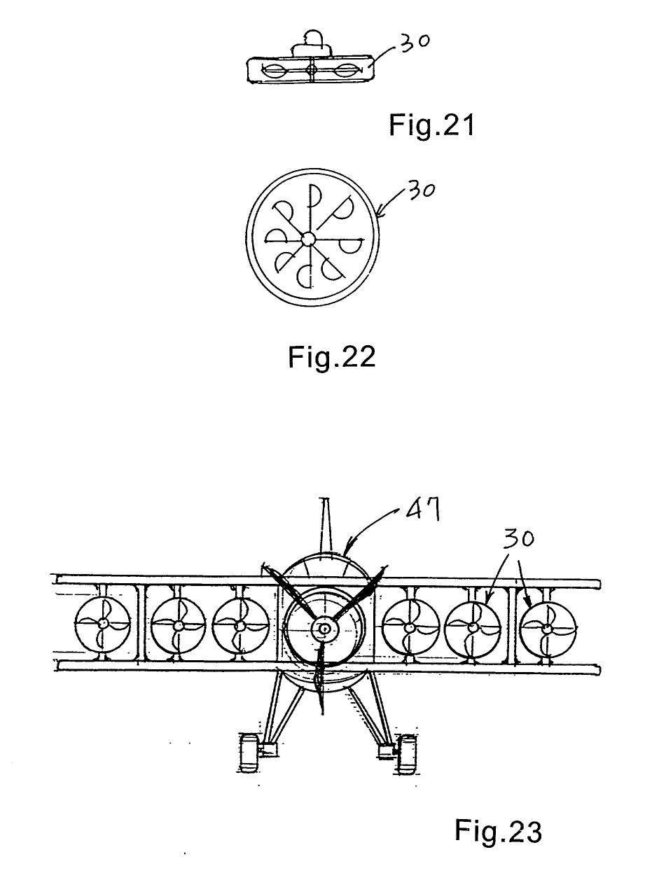

A preferred embodiment of the wind electric power generating unit (30) is that it is fixed on the top of the electric vehicle as shown in FIG. 9 and FIG. 10, on the front top of the vehicle as shown in FIG. 7 or on the back top of the vehicle as shown in FIG. 4 and FIG. 8. Besides, it can also be fixed on two different parts at the same time; or as shown in FIG. 18, to be fixed on the top of the vehicle (40) extending from its front to its back. In this embodiment, the wind electric power-generating unit (30), as shown in FIG. 19 and FIG. 20, consists of two or more sets of turbine generators in series connection. FIG. 16 and FIG. 17 illustrate an embodiment in which there are installed multiple wind electric power generating units (30). FIGS. 13-15 illustrates a wind electric power-generating unit (30) consisting of multiple sets of turbine generators in parallel connection. Moreover, as shown in FIG. 21 and FIG. 22, and please refer to FIG. 5; different from above-mentioned horizontal shaft type turbine generator, the present invention can also be embodied as vertical shaft type turbine generator. When the electric vehicle is running, as shown in FIG. 3, there are fast and strong airflow above the top of the vehicle. No matter which type of wind power generator is employed, either the horizontal one of FIG. 13-FIG. 20 or the vertical one of FIG. 21-FIG. 22, it can gather satisfactory airflow upon the windward side of the vehicle and generate electricity as auxiliary power supply. Furthermore, the present invention can also be embodied as shown in FIG. 6, FIG. 7 and FIG. 8 to have wind electric power generating unit (30) installed at any of the front top, front or back front of the vehicle.

The primary obstacle in utilizing wind power to generate electricity lies in that the airflow is extremely unstable, sometimes strong, and sometimes weak and sometimes even no airflow at all. Because of this, traditional windmill-style wind power generator is not supposed to take place of other means of generating electricity. But what is original in the present invention is that the wind power generator is installed on a transportation vehicle and utilizes the airflow when speeding or even gliding to generate electricity as auxiliary power supply. In short, the device of the present invention is actually the best cooperator to other means of generating electricity on transportation vehicles. It can generate electricity by utilizing airflow gathered when the vehicle is running and replenish power supply and further enhance its endurance. The present invention not only can be applied to newly build electric vehicles, but also can be equipped to the existing ones as auxiliary power supply to improve their performance.

As the flow shown in FIG. 2, the present invention, like traditional electric vehicles, can uses electric supply (20), or solar energy generator (21) or other electric power such as fuel battery (22) to store electricity into its car borne battery (23) in advance. When electric vehicle starts, the battery (23) outputs electricity to motor (24) to operate (25). Some vehicles are even equipped with a minor generator (26) that generates induced current through the revolving of axle to be stored in the main battery (23). However, the present invention specializes in that it utilizes the relative airflow to promote wind power generator (27) to generate electricity to replenish power supply to driving motor and the secondary battery stores input electricity generated by the wind electric power generating unit to drive the vehicle. Basically, it is possible to employ a rectifier and/or voltage manostat unit (29) to control electric current. In other hand, as mentioned above, the present invention can employ a secondary electricity storage device (28) in parallel connection, i.e., the secondary auxiliary battery (31) as shown in FIG. 4. Thus, the device of the present invention has at least two connected batteries, the first one of which, i.e., the main battery (23), directly transmits electricity to the motor, the second of which stores input electricity generated by the wind electric power generating unit as auxiliary power supply.

The above-mentioned embodiments give evidence of the operability of this invention in details. However, if anyone masters this technology and invents a similar system that has difference either in appearance or in details, will be held legal responsibility of trespassing the originality and patent of this invention. Although certain preferred embodiment of the present invention has been shown and described in detail, it should be understood that various changes and modification might be made therein without departing from the scope of the appended claims.

What is claimed is:

1. A device of wind electric power on transportation vehicles comprising at least one wind electric power-generating unit is fixed on the electric vehicle there, and an air inlet of said wind electric power generating unit faces the windward side of the electric vehicle.

2. A device of claim 1, further comprising at least one rechargeable secondary battery is connected to said wind electric power-generating unit and fixed the electric vehicle thereon, and said rechargeable secondary battery stores input electricity generated by wind power said wind electric power generating unit.

3. A device of claim 1, wherein said transportation vehicle is electric vehicle and said wind electric power-generating unit is fixed on the top of said electric vehicle.

4. A device of claim 1, wherein said transportation vehicle is electric vehicle and said wind electric power-generating unit is fixed on the front top of said electric vehicle.

5. A device of claim 1, wherein said transportation vehicle is vessel.

6. A device of claim 5, wherein said wind electric power generating unit is fixed on the top of the deck of said vessel.

7. A device of claim 5, wherein said wind electric power generating unit is fixed on the stern of said vessel.

8. A device of claim 5, wherein said wind electric power generating unit is fixed on at least one of the two gunwales of said vessel.

9. A device of claim 1, wherein said transportation vehicle is electric bicycle and said wind electric power-generating unit is fixed on the front of said electric bicycle.

10. A device of claim 1, wherein said transportation vehicle is electric motorcycle and said wind electric power-generating unit is fixed on the front of said electric motorcycle.

11. A device of claim 1, wherein said transportation vehicle is airplane.

12. A device of claim 11, wherein said wind electric power-generating unit is fixed on the wings of said airplane.

13. A device of claim 1, wherein the air inlet of said wind electric power-generating unit has a pair of air throttles that can be pushed outwards to enlarge cross section area of said air inlet.

14. A device of claim 13, wherein the air throttles is controlled by a driving unit.
